(19) United States
(12) Patent Application Publication
(10) Pub. No.: US 2019/0314250 A1
(43) Pub. Date: Oct. 17, 2019

(54) Trackable Pacifier Assembly

(71) Applicant: Victoria Wood, Carrollton, GA (US)

(72) Inventor: Victoria Wood, Carrollton, GA (US)

(21) Appl. No.: 15/954,683

(22) Filed: Apr. 17, 2018

(51) Int. Cl. A61J 17/00; G08B 7/06

(52) U.S. Cl. CPC A61J 17/005; A61J 17/001; G08B 7/06

(57) ABSTRACT

A trackable pacifier assembly for locating a misplaced pacifier includes a panel that is flexible. A nipple is coupled to and extends from a first face of the panel. The nipple is configured to pacify a child. A tracker unit is coupled to a second face of the panel. The tracker unit comprises a transceiver so that the tracker unit is configured to communicate wirelessly. The tracker unit also comprises a receiver. The receiver is global positioning system enabled so that the receiver is configured to receive coordinates. The transceiver is positioned to communicate the coordinates to an electronic device of a user so that the user is positioned to locate the tracker unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to pacifier assemblies and more particularly pertains to a new pacifier assembly for locating a misplaced pacifier.

### BRIEF SUMMARY OF THE INVENTION

An embodiment of the disclosure meets the needs presented above by generally comprising a panel that is flexible. A nipple is coupled to and extends from a first face of the panel. The nipple is configured to pacify a child. A tracker unit is coupled to a second face of the panel. The tracker unit comprises a transceiver so that the tracker unit is configured to communicate wirelessly. The tracker unit also comprises a receiver. The receiver is global positioning system enabled so that the receiver is configured to receive coordinates. The transceiver is positioned to communicate the coordinates to an electronic device of a user so that the user is positioned to locate the tracker unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a trackable pacifier assembly according to an embodiment of the disclosure.

FIG. 2 is a back view of an embodiment of the disclosure.

FIG. 3 is a front view of an embodiment of the disclosure.

FIG. 4 is a side view of an embodiment of the disclosure.

FIG. 5 is a block diagram of an embodiment of the disclosure.

### DETAILED DESCRIPTION OF THE INVENTION

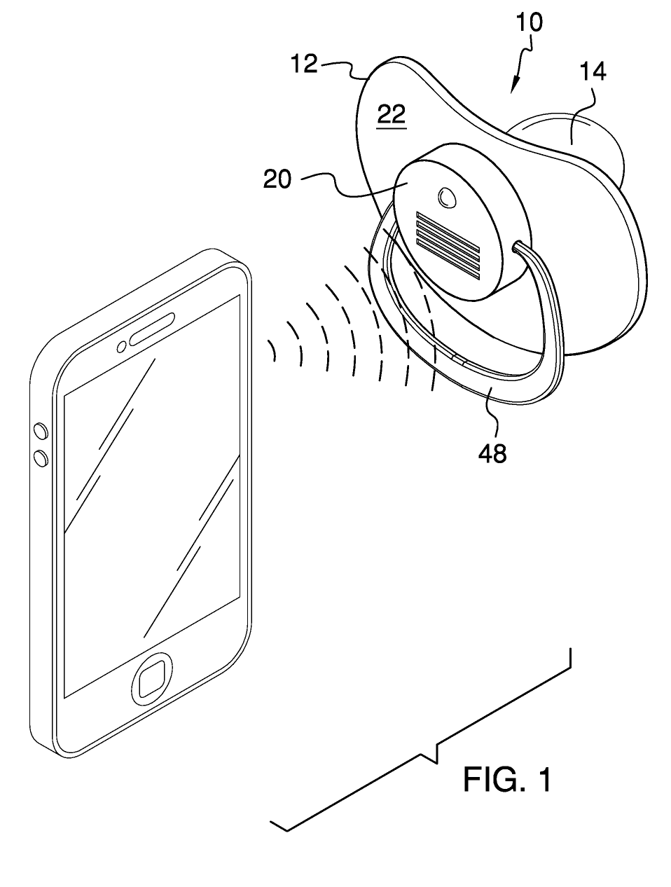

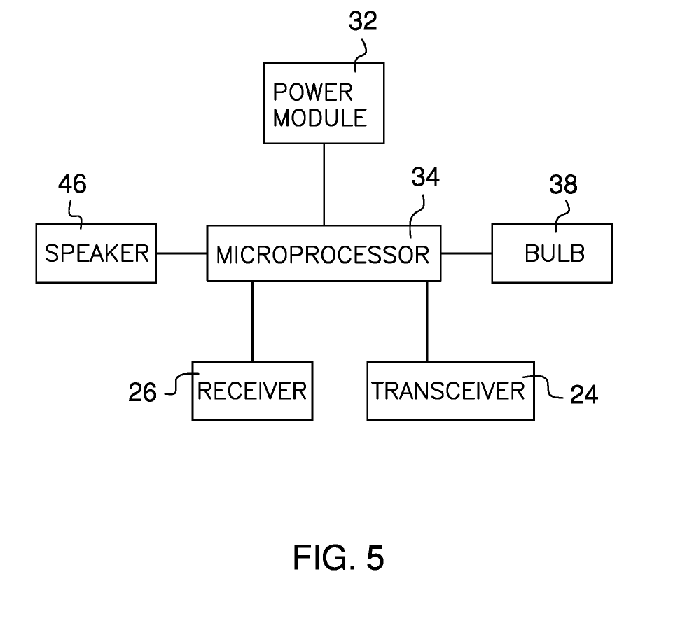

With reference now to the drawings, and in particular to FIGS. 1 through 5 thereof, a new pacifier assembly embodying the principles and concepts of an embodiment of the disclosure and generally designated by the reference numeral 10 will be described.

As best illustrated in FIGS. 1 through 5, the trackable pacifier assembly 10 generally comprises a panel 12 that is flexible. A nipple 14 is coupled to and extends from a first face 16 of the panel 12, as shown in FIG. 3. The nipple 14 is configured to pacify a child. The panel 12 is arcuate such that opposing sides 18 of the panel 12 extend toward a terminus 60 of the nipple 14. The opposing sides 18 are arcuate.

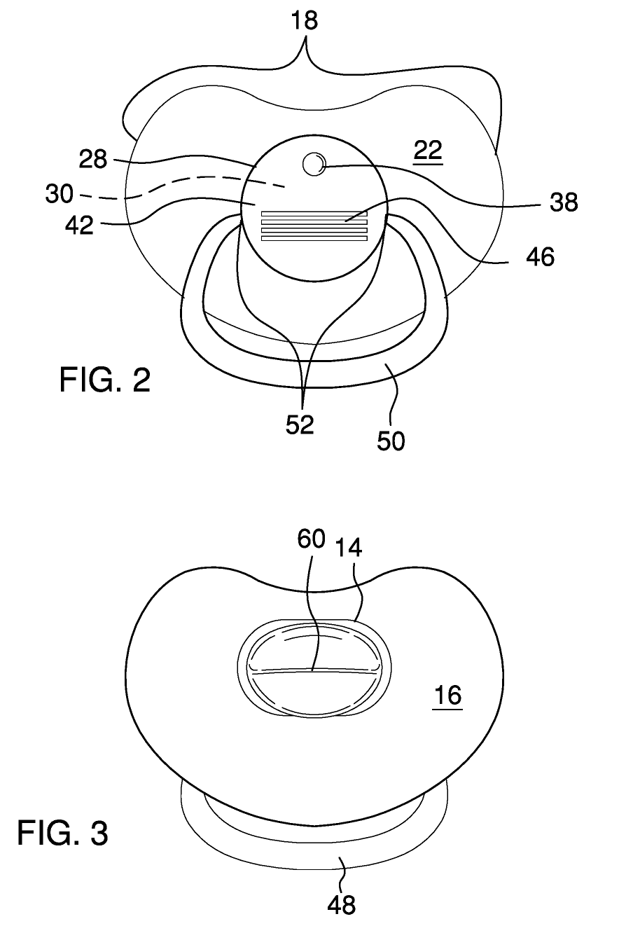

A tracker unit 20 is coupled to a second face 22 of the panel 12, as shown in FIG. 2. The tracker unit 20 comprises a transceiver 24 so that the tracker unit 20 is configured to communicate wirelessly. The tracker unit 20 also comprises a receiver 26.

The receiver 26 is global positioning system enabled so that the receiver 26 is configured to receive coordinates. The transceiver 24 is positioned to communicate the coordinates to an electronic device of a user, positioning the user to locate the tracker unit 20.

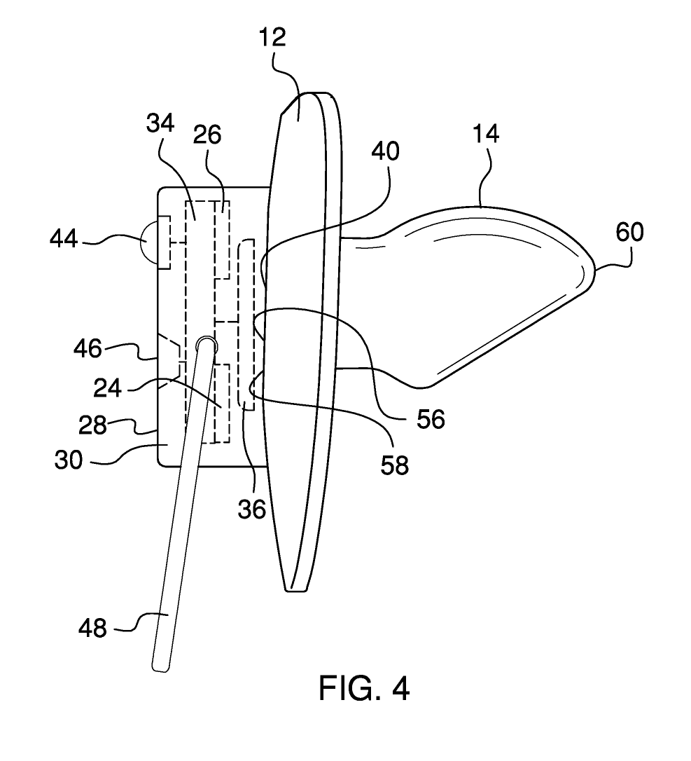

The tracker unit 20 comprises a housing 28 that defines an interior space 30, as shown in FIG. 4. The housing 28 is substantially cylindrically shaped. The housing 28 has a first side 40 that is coupled to the panel 12. The transceiver 24, the receiver 26, a power module 32, and a microprocessor 34 are coupled to the housing 28 and are positioned in the interior space 30. The power module 32 comprises a battery 36. The microprocessor 34 is operationally coupled to the power module 32, the transceiver 24, and the receiver 26. The transceiver 24 is configured to receive a locate signal from the electronic device of the user, as shown in FIG. 1, and to relay the locate signal to the microprocessor 34. The microprocessor 34 actuates the receiver 26 to receive the coordinates and to relay the coordinates to the microprocessor 34. The transceiver 24 is positioned to communicate the coordinates to the electronic device of the user, positioning the user to locate the tracker unit 20.

A bulb 38 is coupled to a second side 42 of the housing 28, as shown in FIG. 2. The bulb 38 comprises a light emitting diode 44. The bulb 38 is operationally coupled to the microprocessor 34. The transceiver 24 is configured to receive an illuminate signal from the electronic device of the user and to relay the illuminate signal to the microprocessor 34. The microprocessor 34 is positioned to actuate the bulb 38 to illuminate to facilitate the user in locating the tracker unit 20.

A speaker 46 is coupled to the second side 42 of the housing 28, as shown in FIG. 2. The speaker 46 is operationally coupled to the microprocessor 34. The transceiver 24 is configured to receive an alert signal from the electronic device of the user and to relay the alert signal to the microprocessor 34. The microprocessor 34 is positioned to actuate the speaker 46 to broadcast an alert to facilitate the user in locating the tracker unit 20.

A handle 48 is coupled to the housing 28. The handle 48 is configured to be grasped in a hand of the user and to be grasped in a hand of the child. The handle 48 comprises a bar 50 that has opposing ends 52. Each opposing end 52 is pivotally coupled to a respective opposing side 54 of the housing 28 so that the bar 50 extends arcuately between the opposing sides 54 of the housing 28.

A coupler 56 is positioned between the tracker unit 20 and the panel 12. The coupler 56 is coupled to the tracker unit 20 and is selectively couplable to the panel 12. The coupler 56 is positioned to selectively couple to the panel 12 to couple the tracker unit 20 to the panel 12. The coupler 56 comprises a reversible adhesive 58, which allows the tracker unit 20 to be coupled selectively to a new panel 12, should the need arise.

In use, the transceiver 24 receives the locate signal from the electronic device of the user and relays the locate signal to the microprocessor 34. The microprocessor 34 actuates the receiver 26 to receive the coordinates and to relay the coordinates to the microprocessor 34. The transceiver 24 communicates the coordinates to the electronic device of the user, positioning the user to locate the tracker unit 20. The user may selectively send the illuminate signal from the electronic device of the user to the transceiver 24, which relays the illuminate signal to the microprocessor 34. The microprocessor 34 actuates the bulb 38 to illuminate to facilitate the user in locating the tracker unit 20. The user may selectively send the alert signal from the electronic device of the user to the transceiver 24, which relays the alert signal to the microprocessor 34. The microprocessor 34 actuates the speaker 46 to broadcast the alert to facilitate the user in locating the tracker unit 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A trackable pacifier assembly comprising:
a panel, said panel being flexible;
a nipple coupled to and extending from a first face of said panel wherein said nipple is configured for pacifying a child; and
a tracker unit coupled to a second face of said panel, said tracker unit comprising a transceiver wherein said tracker unit is configured for wireless communication, said tracker unit comprising a receiver, said receiver being global positioning system enabled wherein said receiver is configured for receiving coordinates positioning said transceiver for communicating the coordinates to an electronic device of a user positioning the user for locating said tracker unit.

2. The assembly of claim 1, further including said panel being arcuate such that opposing sides of said panel extend toward a terminus of said nipple.

3. The assembly of claim 2, further including said opposing sides being arcuate.

4. The assembly of claim 1, further including said tracker unit comprising:
a housing defining an interior space, said housing having a first side coupled to said panel, said transceiver and said receiver being coupled to said housing and positioned in said interior space;
a power module coupled to said housing and positioned in said interior space; and
a microprocessor coupled to said housing and positioned in said interior space, said microprocessor being operationally coupled to said power module, said transceiver, and said receiver wherein said transceiver is configured for receiving a locate signal from the electronic device of the user and for relaying the locate signal to said microprocessor such that said microprocessor actuates said receiver for receiving the coordinates and for relaying the coordinates to said microprocessor positioning said transceiver for communicating the coordinates to the electronic device of the user positioning the user for locating said tracker unit.

5. The assembly of claim 4, further including said housing being substantially cylindrically shaped.

6. The assembly of claim 4, further including said power module comprising a battery.

7. The assembly of claim 4, further including a bulb coupled to a second side of said housing, said bulb being operationally coupled to said microprocessor wherein said transceiver is configured for receiving an illuminate signal from the electronic device of the user and for relaying the illuminate signal to said microprocessor such that said microprocessor is positioned for actuating said bulb for illuminating for facilitating the user in locating said tracker unit.

8. The assembly of claim 7, further including said bulb comprising a light emitting diode.

9. The assembly of claim 4, further including a speaker coupled to a second side of said housing, said speaker being operationally coupled to said microprocessor wherein said transceiver is configured for receiving an alert signal from the electronic device of the user and for relaying the alert signal to said microprocessor such that said microprocessor is positioned for actuating said speaker for broadcasting an alert for facilitating the user in locating said tracker unit.

10. The assembly of claim 4, further including a handle coupled to said housing wherein said handle is configured for grasping in a hand of the user and for grasping in a hand of the child.

11. The assembly of claim 10, further including said handle comprising a bar, said bar having opposing ends, each said opposing end being pivotally coupled to a respective opposing side of said housing such that said bar extends arcuately between said opposing sides of said housing.

12. The assembly of claim 1, further including a coupler positioned between said tracker unit and said panel, said coupler being coupled to said tracker unit and selectively couplable to said panel wherein said coupler is positioned for selectively coupling to said panel for coupling said tracker unit to said panel.

13. The assembly of claim 12, further including said coupler comprising a reversible adhesive.

14. A trackable pacifier assembly comprising:
a panel, said panel being flexible;
a nipple coupled to and extending from a first face of said panel wherein said nipple is configured for pacifying a child, said panel being arcuate such that opposing sides of said panel extend toward a terminus of said nipple, said opposing sides being arcuate;
a tracker unit coupled to a second face of said panel, said tracker unit comprising a transceiver wherein said tracker unit is configured for wireless communication, said tracker unit comprising a receiver, said receiver being global positioning system enabled wherein said receiver is configured for receiving coordinates positioning said transceiver for communicating the coordinates to an electronic device of a user positioning the user for locating said tracker unit, said tracker unit comprising:
a housing defining an interior space, said housing having a first side coupled to said panel, said transceiver and said receiver being coupled to said housing and positioned in said interior space, said housing being substantially cylindrically shaped,
a power module coupled to said housing and positioned in said interior space, said power module comprising a battery,
a microprocessor coupled to said housing and positioned in said interior space, said microprocessor being operationally coupled to said power module, said transceiver, and said receiver wherein said transceiver is configured for receiving a locate signal from the electronic device of the user and for relaying the locate signal to said microprocessor such that said microprocessor actuates said receiver for receiving the coordinates and for relaying the coordinates to said microprocessor positioning said transceiver for communicating the coordinates to the electronic device of the user positioning the user for locating said tracker unit,
a bulb coupled to a second side of said housing, said bulb being operationally coupled to said microprocessor wherein said transceiver is configured for receiving an illuminate signal from the electronic device of the user and for relaying the illuminate signal to said microprocessor such that said microprocessor is positioned for actuating said bulb for illuminating for facilitating the user in locating said tracker unit, said bulb comprising a light emitting diode, and
a speaker coupled to said second side of said housing, said speaker being operationally coupled to said microprocessor wherein said transceiver is configured for receiving an alert signal from the electronic device of the user and for relaying the alert signal to said microprocessor such that said microprocessor is positioned for actuating said speaker for broadcasting an alert for facilitating the user in locating said tracker unit;
a handle coupled to said housing wherein said handle is configured for grasping in a hand of the user and for grasping in a hand of the child, said handle comprising a bar, said bar having opposing ends, each said opposing end being pivotally coupled to a respective opposing side of said housing such that said bar extends arcuately between said opposing sides of said housing; and
a coupler positioned between said tracker unit and said panel, said coupler being coupled to said tracker unit and selectively couplable to said panel wherein said coupler is positioned for selectively coupling to said panel for coupling said tracker unit to said panel, said coupler comprising a reversible adhesive.
